(19) United States
(12) Patent Application Publication
(10) Pub. No.: US 2025/0319396 A1
(43) Pub. Date: Oct. 16, 2025

(54) ONE OR MORE NON-TRANSITORY COMPUTER-READABLE MEDIA, INFORMATION PROCESSING SYSTEM, INFORMATION PROCESSING METHOD, AND INFORMATION PROCESSING APPARATUS

(71) Applicant: NINTENDO CO., LTD., Kyoto (JP)

(72) Inventors: Koichi KAWAMOTO, Kyoto (JP); Yuki SAKAMOTO, Kyoto (JP)

(21) Appl. No.: 19/097,149

(22) Filed: Apr. 1, 2025

(30) Foreign Application Priority Data
Apr. 11, 2024 (JP) 2024-063865

(51) Int. Cl. A63F 13/52; G06T 11/00

(52) U.S. Cl. CPC A63F 13/52; G06T 11/00; G06T 2200/24

(57) ABSTRACT

An information processing system includes a parent apparatus and a child apparatus. The parent apparatus acquires parent apparatus operation data relating to an operation on an operation device of the parent apparatus and acquires child apparatus operation data from the child apparatus. The parent apparatus performs information processing based on the parent apparatus operation data and the received child apparatus operation data and generates a first image and a second image that is a UI image based on the information processing. The parent apparatus outputs one of the first image and the second image to a display device of the parent apparatus and transmits the other image to the child apparatus. The child apparatus transmits the child apparatus operation data relating to an operation on an operation device of the child apparatus to the parent apparatus and outputs the other image received from the parent apparatus to a display device.

### CROSS REFERENCE TO RELATED APPLICATION

This application claims priority to Japanese Patent Application No. 2024-063865 filed on Apr. 11, 2024, the entire contents of which are incorporated herein by reference.

### FIELD

An exemplary embodiment relates to one or more non-transitory computer-readable media, an information processing system, an information processing method, and an information processing apparatus.

### BACKGROUND AND SUMMARY

Conventionally, there is a technique in which one of a plurality of information processing apparatuses is set as a parent apparatus, the other apparatuses are set as child apparatuses, and the parent apparatus distributes images to the child apparatuses, whereby a game is performed between the plurality of information processing apparatuses.

However, there is room for improvement in convenience for a user using an information processing system having the function of distributing images from a parent apparatus to child apparatuses.

An exemplary embodiment discloses an information processing system having the function of distributing images from a parent apparatus to child apparatuses and capable of improving convenience for a user.

The exemplary embodiment employs the following configurations.

### First Configuration

A first configuration is one or more non-transitory computer-readable media having stored therein instructions that, when executed, cause one or more processors of a first information processing apparatus to execute information processing. The information processing includes, in a first mode, performing information processing using first input data based on an operation input to an operation device included in or connected to the first information processing apparatus as operation data, and outputting an image including one of a first image and a second image selected in a switchable manner based on the operation data or both the first image and the second image to a display device included in or connected to the first information processing apparatus. The information processing includes, in a second mode, communicating with a second information processing apparatus, performing the information processing using at least either of first input data and second input data received from the second information processing apparatus as the operation data, outputting one of the first image and the second image to the display device, and transmitting the other image to the second information processing apparatus.

Based on the above, if there is only a first information processing apparatus, a first image and a second image that is a UI image are displayed on a display device of the first information processing apparatus, and if there is a second information processing apparatus in addition to the first information processing apparatus, one of the first image and the second image is displayed on the first information processing apparatus, and the other image is transmitted to the second information processing apparatus. Consequently, if there is the second information processing apparatus in addition to the first information processing apparatus, it is possible to display the first image and the second image that is the UI image on difference display devices, and improve convenience for a user.

### Second Configuration

According to a second configuration, in the first configuration, the information processing may be game processing, and the first image may be an image of a virtual space based on a virtual camera.

Based on the above, it is possible to perform game processing and generate an image based on a virtual camera as the first image.

### Third Configuration

According to a third configuration, in the second configuration, the second image may at least include a map image in a game.

Based on the above, while viewing the image based on the virtual camera, the user can view a map image on a different screen.

### Fourth Configuration

According to the fourth configuration, in the first configuration, the second image may at least include an image representing an item as a selection target. The information processing may further include performing a selection process for selecting the item at least based on the operation data.

Based on the above, the user can select an item as a selection target on a different screen.

### Fifth Configuration

According to the fifth configuration, in the fourth configuration, the item may be a composition. The information processing may further include; and generating an image related to the composition that is being reproduced as the first image.

Based on the above, it is possible to select a composition on a different screen, start the production of the composition, and display an image related to the selected composition as the first image.

### Sixth Configuration

According to the sixth configuration, in the first configuration, the second input data may include touch input data regarding an input to a touch panel provided in the second information processing apparatus. The information processing may further include, in the second mode, performing the information processing using the second input data as the operation data, and selecting a selectable item included in a UI of the second image based on the touch input data.

Based on the above, the user can select a selectable item using a touch panel.

Another configuration may be the first information processing apparatus, or may be an information processing system including the first information processing apparatus, or may be an information processing method performed in an information processing system.

According to the exemplary embodiment, if there is a second information processing apparatus in addition to a first information processing apparatus, it is possible to display a first image and a second image that is a UI image on different display devices, and improve convenience for a user.

These and other features, aspects and advantages of the exemplary embodiments will become more apparent from the following detailed description of the exemplary embodiments when taken in conjunction with the accompanying drawings.

### BRIEF DESCRIPTION OF THE DRAWINGS

FIG. 1 is an example non-limiting diagram showing an example of an information processing apparatus 1 in the state where a left controller 3 and a right controller 4 are attached to a main body apparatus 2;

FIG. 2 is an example non-limiting diagram showing an example of the information processing apparatus 1 in the state where the left controller 3 and the right controller 4 are detached from the main body apparatus 2;

FIG. 3 is an example non-limiting block diagram showing an example of the internal configuration of the information processing apparatus 1;

FIG. 4 is an example non-limiting diagram showing an example of a game system 10 and is an example non-limiting diagram showing an overview of the game system 10 configured by a plurality of information processing apparatuses 1 performing local communication with each other;

FIG. 5 is an example non-limiting diagram showing an example of the game system 10 and is an example non-limiting diagram showing an overview of the game system 10 configured by the plurality of information processing apparatuses 1 performing Internet communication with each other;

FIG. 6 is an example non-limiting diagram showing an example of the configuration of the game system 10 where a game according to an exemplary embodiment is performed;

FIG. 7 is an example non-limiting diagram showing an example of a second image displayed on a display 12b of a child apparatus in a case where the game according to the exemplary embodiment is performed;

FIG. 8 is an example non-limiting diagram showing another example of the second image displayed on the display 12b of the child apparatus in a case where the game according to the exemplary embodiment is performed;

FIG. 9 is an example non-limiting diagram showing an example of a first image displayed on a stationary monitor 5 connected to a parent apparatus in a case where the game according to the exemplary embodiment is performed;

FIG. 10 is an example non-limiting diagram showing an example of, in a case where the game according to the exemplary embodiment is executed using a single information processing apparatus 1, an image displayed on a display device of the information processing apparatus 1;

FIG. 11 is an example non-limiting diagram showing an example of the first image displayed on the stationary monitor 5 connected to the information processing apparatus 1 in a case where the game is performed in a single-screen mode;

FIG. 12 is an example non-limiting diagram showing an example of the second image displayed on the stationary monitor 5 connected to the information processing apparatus 1 in a case where the game is performed in the single-screen mode;

FIG. 13 is an example non-limiting diagram showing an example of the second image displayed on the display 12b of the child apparatus in a case where a predetermined application is executed;

FIG. 14 is an example non-limiting diagram showing an example of the second image displayed on the display 12b of the child apparatus in a case where the predetermined application is executed;

FIG. 15 is an example non-limiting diagram showing an example of the first image displayed on the stationary monitor 5 connected to the parent apparatus in a case where the predetermined application is executed;

FIG. 16 is an example non-limiting diagram showing an example of data stored in a parent apparatus;

FIG. 17 is an example non-limiting diagram showing an example of data stored in a child apparatus;

FIG. 18 is an example non-limiting flow chart showing an example of a parent apparatus process performed by the parent apparatus; and

FIG. 19 is an example non-limiting flow chart showing an example of a child apparatus process performed by the child apparatus.

### DETAILED DESCRIPTION OF NON-LIMITING EXAMPLE EMBODIMENTS

### Description of Information Processing Apparatus

An information processing apparatus used in an example of an exemplary embodiment is described below. An example of an information processing apparatus 1 includes a main body apparatus 2, a left controller 3, and a right controller 4. Each of the left controller 3 and the right controller 4 is configured to be attachable to and detachable from the main body apparatus 2. That is, the information processing apparatus 1 can be used as a unified apparatus obtained by attaching the left controller 3 and the right controller 4 to the main body apparatus 2. Further, the information processing apparatus 1 can also be used by detaching the left controller 3 and the right controller 4 from the main body apparatus 2. Hereinafter, the configuration of the information processing apparatus 1 according to the exemplary embodiment is described, and then, a game system including a plurality of information processing apparatuses 1 is described.

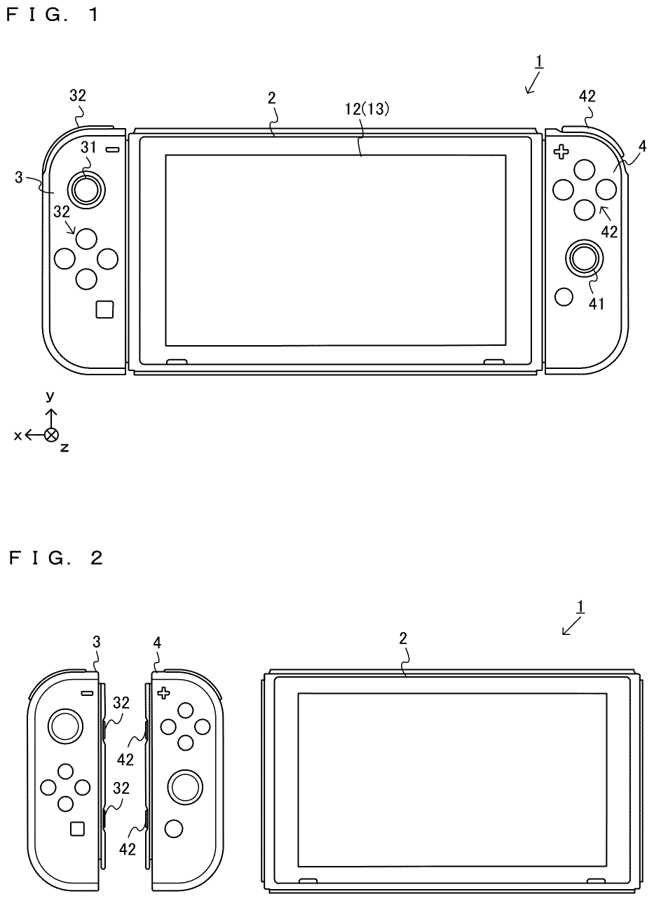

FIG. 1 is a diagram showing an example of the information processing apparatus 1 in the state where the left controller 3 and the right controller 4 are attached to the main body apparatus 2. FIG. 2 is a diagram showing an example of the information processing apparatus 1 in the state where the left controller 3 and the right controller 4 are detached from the main body apparatus 2. As shown in FIG. 1, each of the left controller 3 and the right controller 4 is attached to and unified with the main body apparatus 2. The main body apparatus 2 is an apparatus for performing various processes (e.g., game processing) in the information processing apparatus 1.

The main body apparatus 2 includes a display 12. The display 12 displays an image generated by the main body apparatus 2. The display 12 may be a display device of any type. For example, the display 12 may be a liquid crystal display device (LCD), or may be an organic EL display device.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

Each of the left controller 3 and the right controller 4 has a vertically long shape (i.e., a long shape in a y-axis direction shown in FIG. 1). In the state where each of the left controller 3 and the right controller 4 is detached from the main body apparatus 2, the controller can be held in the orientation in which the controller is vertically long, and can also be held in the orientation in which the controller is horizontally long.

The left controller 3 includes an analog stick 31 for a user to provide a direction input, and a plurality of operation buttons 32 for the user to perform a pressing operation. The right controller 4 includes an analog stick 41 for the user to provide a direction input, and a plurality of operation buttons 42 for the user to perform a pressing operation. Each of the left controller 3 and the right controller 4 may include an acceleration sensor and an angular velocity sensor within and be able to detect the motion and the orientation of the controller. Hereinafter, the left controller 3 and the right controller 4 are occasionally collectively referred to as a “first controller”.

The main body apparatus 2 to which the left controller 3 and the right controller 4 are attached (the information processing apparatus 1) is of a size that can be carried by the user. For example, the user performs a game operation using the left controller 3 and the right controller 4 by holding the left controller 3 unified with the main body apparatus 2 with their left hand and holding the right controller 4 unified with the main body apparatus 2 with their right hand and plays a game while viewing a game image displayed on the display 12 in front of the user. Hereinafter, a play form in which as described above, in the state where the left controller 3 and the right controller 4 are attached to the main body apparatus 2, the user performs a game operation using the left controller 3 and the right controller 4 and plays a game while viewing a game image displayed on the display 12 is occasionally referred to as a “mobile mode”.

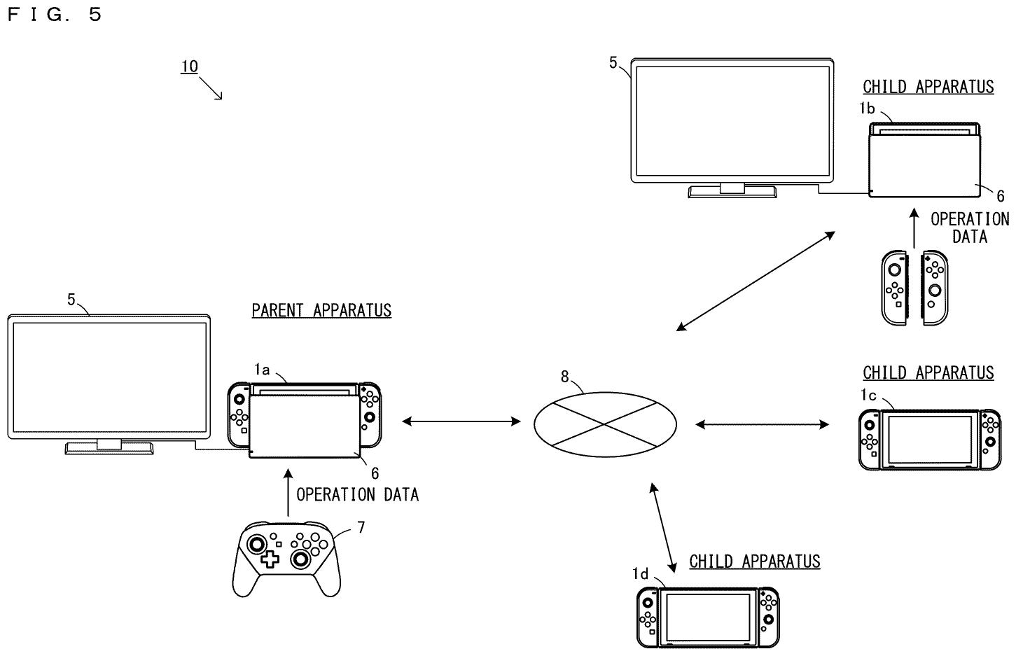

As shown in FIG. 2, the left controller 3 and the right controller 4 can be detached from the main body apparatus 2. In the state where the left controller 3 and the right controller 4 are detached from the main body apparatus 2, the left controller 3 and the right controller 4 are wirelessly connected to the main body apparatus 2. For example, a stand for standing the main body apparatus 2 is provided on a back surface of the main body apparatus 2. Using the stand, the user can place the main body apparatus 2 in the state where the main body apparatus 2 stands on a table so that the screen of the display 12 is almost perpendicular to the table. Alternatively, the user may place the main body apparatus 2 on the table so that the screen of the display 12 of the main body apparatus 2 faces up. The user can detach the left controller 3 and the right controller 4 from the main body apparatus 2, perform a game operation using the left controller 3 and/or the right controller 4, and play a game while viewing a game image displayed on the display 12 of the main body apparatus 2 placed on the table. Hereinafter, a play form in which as described above, the left controller 3 and the right controller 4 are wirelessly connected to the main body apparatus 2, and the user performs a game operation using the left controller 3 and/or the right controller 4 and plays a game while viewing a game image displayed on the display 12 is occasionally referred to as a “table mode”. To the main body apparatus 2, a second controller 7 (see FIG. 5) different from the left controller 3 and the right controller 4 may be able to be wirelessly connected. The second controller may be a controller that can be operated by the user by holding the controller with both hands. A play form in which as described above, the second controller is wirelessly connected to the main body apparatus 2, and the user performs a game operation using the second controller and plays a game while viewing a game image displayed on the display 12 is also referred to as a “table mode”. Hereinafter, the first controller and the second controller are occasionally collectively referred to as a “controller”.

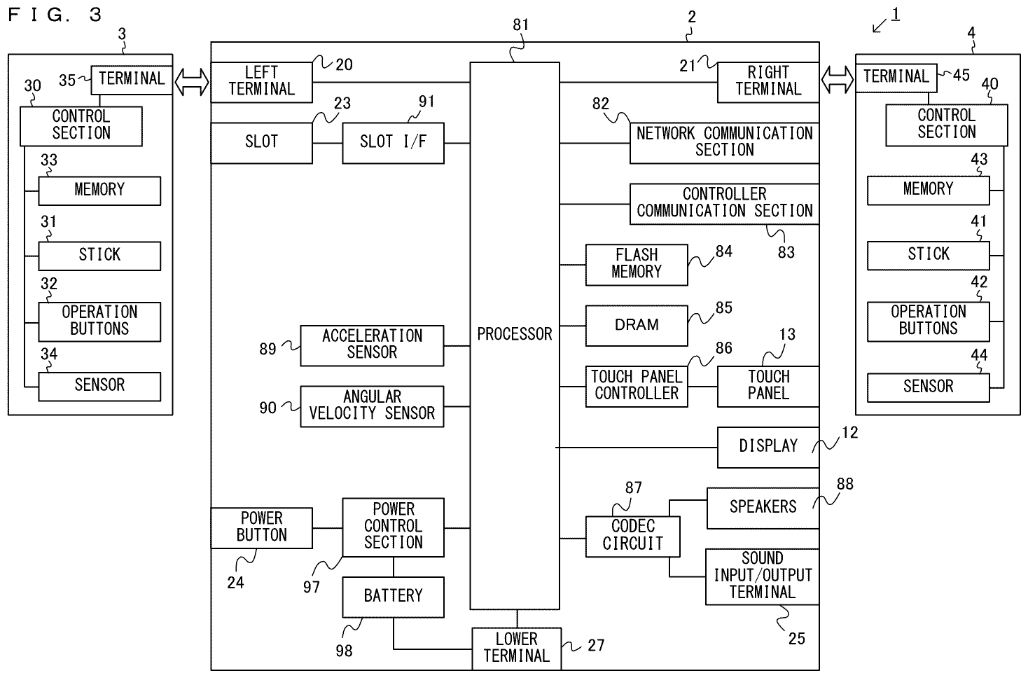

The user can also connect the main body apparatus 2 to a stationary monitor (e.g., television) 5 via a cradle 6 and play a game while viewing a game image displayed on the stationary monitor 5 (see FIG. 5). In the main body apparatus 2, a lower terminal 27 (see FIG. 3) for connecting to the cradle 6 is provided. The main body apparatus 2 is connected to the stationary monitor 5 in a wired manner via the cradle 6. A play form in which as described above, the user plays a game while viewing an image displayed on the external stationary monitor 5 different from the display 12 is occasionally referred to as a “stationary mode”. In a case where the information processing apparatus 1 operates in the stationary mode, the first controller (the left controller 3 and the right controller 4) may be detached from the main body apparatus 2 and wirelessly connected to the main body apparatus 2, and the user may perform a game operation using the first controller. Alternatively, in a case where the information processing apparatus 1 operates in the stationary mode, in the state where the left controller 3 and the right controller 4 are attached to the main body apparatus 2, another first controller or the second controller may be wirelessly connected to the main body apparatus 2, and the user may perform a game operation using the first controller or the second controller.

Next, the internal configuration of the information processing apparatus 1 is described. FIG. 3 is a block diagram showing an example of the internal configuration of the information processing apparatus 1.

As shown in FIG. 3, the main body apparatus 2 includes a processor 81. The processor 81 is an information processing section for executing various types of information processing to be executed by the main body apparatus 2. For example, the processor 81 may be composed of one or more CPUs (Central Processing Units), or may be composed of a SoC (System-on-a-chip) including one or more CPUs and one or more GPUs (Graphics Processing Units). The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, the network communication section 82 can directly wirelessly communicate with another main body apparatus 2 present in the communication range of this main body apparatus 2 using a predetermined communication method (e.g., a communication method based on a unique protocol or a method compliant with the Wi-Fi standard). Via a wireless LAN access point present in the communication range of this main body apparatus 2, the network communication section 82 may also be able to communicate with another main body apparatus 2 connected to a local area network including the access point using a method compliant with the Wi-Fi standard. Here, such direct communication with another main body apparatus 2 and such communication in a local area network via a wireless LAN access point are referred to as “local communication”. The network communication section 82 can connect to the Internet by connecting to a wireless LAN using a method compliant with the Wi-Fi standard, and can communicate with another apparatus connected to the Internet. The main body apparatus 2 may be able to connect to a wired LAN, and may be able to connect to the Internet via the wired LAN. For example, the main body apparatus 2 may be able to connect to the wired LAN via the cradle 6. Here, such communication with another apparatus via the Internet is referred to as “Internet communication”.

The main body apparatus 2 includes a controller communication section 83. The controller communication section 83 is connected to the processor 81. The controller communication section 83 wirelessly communicates with the left controller 3 and/or the right controller 4. The controller communication section 83 can also wirelessly communicate with the second controller. The communication method between the main body apparatus 2 and the left controller 3 and the right controller 4 (or the second controller) is optional. In the exemplary embodiment, the controller communication section 83 performs communication compliant with the Bluetooth (registered trademark) standard with the left controller 3 and with the right controller 4.

The processor 81 is connected to a left terminal 20, a right terminal 21, and a lower terminal 27. When performing wired communication with the left controller 3, the processor 81 transmits data to the left controller 3 via the left terminal 20 and also receives operation data from the left controller 3 via the left terminal 20. Further, when performing wired communication with the right controller 4, the processor 81 transmits data to the right controller 4 via the right terminal 21 and also receives operation data from the right controller 4 via the right terminal 21. Further, when communicating with the cradle 6, the processor 81 transmits data to the cradle 6 via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle 6, the main body apparatus 2 can output data (e.g., image data or sound data) to the stationary monitor 5 or the like via the cradle 6.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. Based on a signal from the touch panel 13, the touch panel controller 86 generates, for example, data indicating the position where a touch input is provided. Then, the touch panel controller 86 outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

Further, the main body apparatus 2 includes an acceleration sensor 89. In the exemplary embodiment, the acceleration sensor 89 detects the magnitudes of accelerations along predetermined three axial (e.g., xyz axes shown in FIG. 1) directions. It should be noted that the acceleration sensor 89 may detect an acceleration along one axial direction or accelerations along two axial directions.

Further, the main body apparatus 2 includes an angular velocity sensor 90. In the exemplary embodiment, the angular velocity sensor 90 detects angular velocities about predetermined three axes (e.g., the xyz axes shown in FIG. 1). It should be noted that the angular velocity sensor 90 may detect an angular velocity about one axis or angular velocities about two axes.

The acceleration sensor 89 and the angular velocity sensor 90 are connected to the processor 81, and the detection results of the acceleration sensor 89 and the angular velocity sensor 90 are output to the processor 81. Based on the detection results of the acceleration sensor 89 and the angular velocity sensor 90, the processor 81 can calculate information regarding the motion and/or the orientation of the main body apparatus 2.

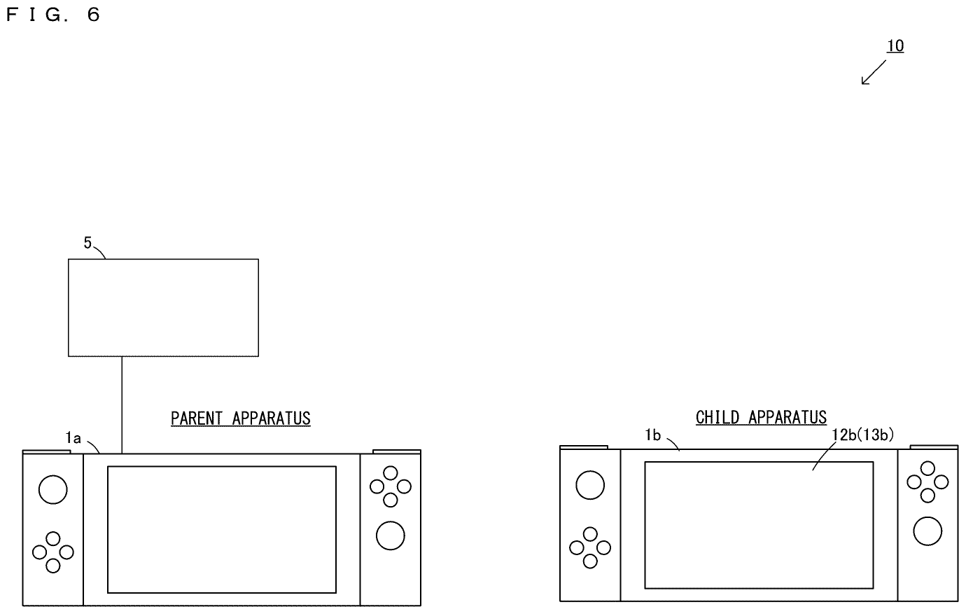

The main body apparatus 2 includes a power button 24, a power control section 97, and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 20, and the right terminal 21). Based on a command from the processor 81, the power control section 97 controls the supply of power from the battery 98 to the above components.

Further, the battery 98 is connected to the lower terminal 27. When an external charging device (e.g., the cradle 6) is connected to the lower terminal 27, and power is supplied to the main body apparatus 2 via the lower terminal 27, the battery 98 is charged with the supplied power.

The left controller 3 includes a terminal 35 that is connected to the left terminal 20 of the main body apparatus 2. The left controller 3 also includes a control section 30. The control section 30 is connected to components including the terminal 35. The control section 30 controls the method for communication performed by the left controller 3 with the main body apparatus 2. In the exemplary embodiment, the control section 30 can communicate with the main body apparatus 2 through both wired communication via the terminal 35 and wireless communication via an antenna (not shown). That is, when the left controller 3 is attached to the main body apparatus 2, the control section 30 communicates with the main body apparatus 2 via the terminal 35. Further, when the left controller 3 is detached from the main body apparatus 2, the control section 30 wirelessly communicates with the main body apparatus 2 (specifically, the controller communication section 83). The wireless communication between the controller communication section 83 and the control section 30 is performed in accordance with the Bluetooth (registered trademark) standard, for example.

Further, the left controller 3 includes a memory 33 such as a flash memory. The control section 30 includes, for example, a microcomputer (or a microprocessor) and executes firmware stored in the memory 33, thereby performing various processes.

The left controller 3 includes the analog stick (“stick” in FIG. 3) 31 and the plurality of operation buttons 32. Information regarding an operation performed on each of the analog stick 31 and the plurality of operation buttons 32 is output to the control section 30 repeatedly at appropriate timing.

Further, the left controller 3 includes a sensor 34. The sensor 34 includes an acceleration sensor and an angular velocity sensor. The acceleration sensor detects the magnitudes of accelerations along the xyz axis directions shown in FIG. 1, and the angular velocity sensor detects angular velocities about the xyz axes. The detection results of the acceleration sensor and the angular velocity sensor are output to the control section 30 repeatedly at appropriate timing.

The control section 30 acquires information regarding an input (specifically, information regarding an operation on each of the analog stick 31 and the operation buttons 32 or the detection result of the sensor 34) from each of the operation buttons 32, the analog stick 31, and the sensor 34. The control section 30 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can determine operations on the analog stick 31 and the operation buttons 32 based on the operation data. Further, based on the detection result of the sensor 34, the main body apparatus 2 can acquire information regarding the motion and/or the orientation of the left controller 3.

Although not shown in the figures, the left controller 3 includes a battery that supplies power to the above components. The left controller 3 may also include a vibrator.

As shown in FIG. 3, the right controller 4 includes a terminal 45 that is connected to the right terminal 21 of the main body apparatus 2, a control section 40, a memory 43, a stick 41, a plurality of operation buttons 42, and a sensor 44. These components have functions similar to those of the above components of the left controller 3, and therefore are not described.

### Description of Game System Including Plurality of Information Processing Apparatuses

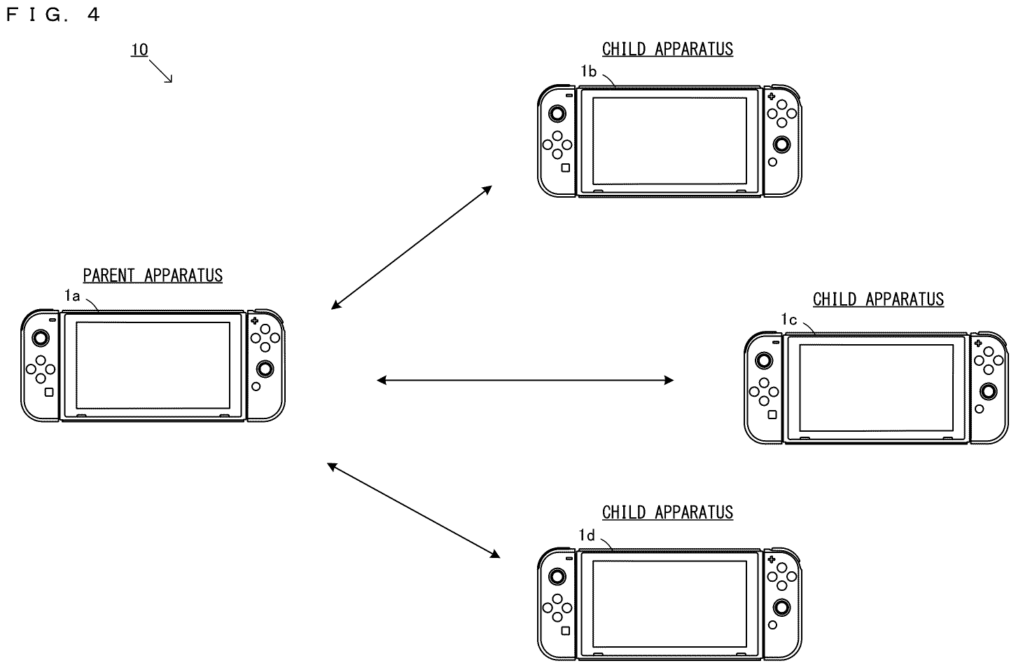

A description is given below of an example of a game system 10 for performing a game according to the exemplary embodiment described below. The game system 10 is a system configured by a plurality of information processing apparatuses 1 communicating with each other. FIG. 4 is a diagram showing an example of the game system 10 and is a diagram showing an overview of the game system 10 configured by the plurality of information processing apparatuses 1 performing the local communication with each other. FIG. 5 is a diagram showing an example of the game system 10 and is a diagram showing an overview of the game system 10 configured by the plurality of information processing apparatuses 1 performing the Internet communication with each other.

As shown in FIGS. 4 and 5, the game system 10 includes a plurality of information processing apparatuses 1. For example, the game system 10 includes an information processing apparatus 1a, an information processing apparatus 1b, an information processing apparatus 1c, and an information processing apparatus 1d.

Although FIGS. 4 and 5 exemplify cases where the game system 10 includes four information processing apparatuses 1, the number of information processing apparatuses 1 included in the game system 10 may be optional. In both the communication forms shown in FIGS. 4 and 5, the plurality of information processing apparatuses 1 included in the game system 10 may operate in the mobile mode, or may operate in the stationary mode, or may operate in the table mode, or these modes may coexist. For example, in the communication form shown in FIG. 4, all the information processing apparatuses 1a to 1d may operate in the mobile mode, or may operate in the stationary mode, or may operate in the table mode, or the mobile mode, the stationary mode, and the table mode may coexist. Although in the game system 10 shown in FIG. 5, information processing apparatuses in the stationary mode (1a and 1b) and information processing apparatuses in the mobile mode (1c and 1d) coexist, an information processing apparatus in the table mode may be included, or all the information processing apparatuses 1a to 1d may operate in the mobile mode, or may operate in the stationary mode, or may operate in the table mode.

In FIGS. 4 and 5, the information processing apparatus 1a functions as a parent apparatus. The information processing apparatus 1a as the parent apparatus executes a game program. The processor 81 of the information processing apparatus 1a executes the game program, thereby executing game processing regarding a predetermined game. For example, an external storage medium that stores the game program can be attached to the slot 23 of the information processing apparatus 1a, and the processor 81 of the information processing apparatus 1a can read the game program stored in the external storage medium into the DRAM 85 and execute the game program. The game program may be stored in the flash memory 84 of the information processing apparatus 1a, or may be stored in another storage device that can be read by the information processing apparatus 1a. The predetermined game may be any game such as a racing game, a card game, a table game, a sport game, a fighting game, a shooting game, a role-playing game, a music game, or the like.

On the other hand, in FIGS. 4 and 5, the information processing apparatuses 1b to 1d function as child apparatuses. Each of the information processing apparatuses 1b to 1d as the child apparatuses may not store the game program for executing the predetermined game and not be able to execute the game program. That is, an external storage medium that stores the game program is not attached to the slot 23 of the child apparatus, and the game program is not stored in the flash memory 84 of the child apparatus, either.

Each child apparatus may also store the game program, but any one of the plurality of information processing apparatuses 1 may function as a parent apparatus, the remaining information processing apparatuses 1 may function as child apparatuses, and only the parent apparatus may execute game processing.

A plurality of child apparatuses may include an apparatus that only functions as a child apparatus.

A parent apparatus and child apparatuses may be information processing apparatuses of same type (e.g., game apparatuses of the same type). A parent apparatus and child apparatuses may be information processing apparatuses of different types. A plurality of child apparatuses may include an information processing apparatus of the same type as a parent apparatus and an information processing apparatus of a different type from the parent apparatus.

As shown in FIG. 4, a parent apparatus and child apparatuses may directly communicate with each other through local communication (e.g., a communication method based on a unique protocol or a method compliant with the Wi-Fi standard). As shown in FIG. 5, a parent apparatus and child apparatuses may communicate with each other via the Internet 8. In the exemplary embodiment, a predetermined game is executed using a parent apparatus and child apparatuses. The parent apparatus and the child apparatuses establish connections with each other before the predetermined game starts.

Specifically, a parent apparatus acquires operation data relating to an operation on the controller (the first controller or the second controller) of the parent apparatus. Here, the operation data relating to an operation on the controller of the parent apparatus is referred to as “parent apparatus operation data”. A child apparatus transmits operation data relating to an operation on the controller (the first controller or the second controller) of the child apparatus to the parent apparatus. Here, the operation data transmitted from the child apparatus to the parent apparatus is referred to as “child apparatus operation data”.

The parent apparatus performs game processing based on the parent apparatus operation data. The parent apparatus also receives the child apparatus operation data transmitted from the child apparatus and performs game processing based on the child apparatus operation data. The content of the game processing differs depending on the type of the game.

Next, the parent apparatus generates image data based on the result of the game processing. Specifically, the parent apparatus generates parent apparatus image data and child apparatus image data.

The parent apparatus outputs the generated parent apparatus image data to the display 12 or the stationary monitor 5. Consequently, a parent apparatus game image is displayed on the display 12 or the stationary monitor 5 of the parent apparatus. The parent apparatus also transmits the generated child apparatus image data to the child apparatus. The child apparatus receives the child apparatus image data transmitted from the parent apparatus and outputs the child apparatus image data to the display 12 or the stationary monitor 5. Consequently, a child apparatus game image is displayed on the display 12 or the stationary monitor 5 of the child apparatus. The parent apparatus may generate parent apparatus sound data and output a sound based on the sound data. The parent apparatus may also generate child apparatus sound data and transmit the child apparatus sound data to the child apparatus, and the child apparatus may output a sound based on the child apparatus sound data.

As described above, the game system 10 for performing the game according to the exemplary embodiment includes a plurality of information processing apparatuses 1, any one of the plurality of information processing apparatuses 1 functions as a parent apparatus, and the other information processing apparatuses 1 function as child apparatuses. Game processing is performed based on parent apparatus operation data relating to an operation performed on the parent apparatus. Child apparatus operation data relating to an operation performed on each child apparatus is transmitted from the child apparatus to the parent apparatus, and game processing based on the child apparatus operation data is performed by the parent apparatus. The parent apparatus generates a game image relating to the result of the game processing and displays the game image on the display 12 or the stationary monitor 5 of the parent apparatus. The parent apparatus also transmits a game image relating to the result of the game processing to the child apparatus, and the game image is displayed by the child apparatus. Consequently, a game is performed in the game system 10 including the parent apparatus and the child apparatuses.

Next, a description is given of the game according to the exemplary embodiment performed using the game system 10 as described above.

### Exemplification of Game Performed in Game System

A game according to the exemplary embodiment is performed using a game system 10 configured by the above local communication. The game according to the exemplary embodiment is a game that uses two information processing apparatuses 1. A first image is displayed on a display device of a first information processing apparatus 1, and a second image that is an image of a user interface (UI) is displayed on a display device of a second information processing apparatus 1.

FIG. 6 is a diagram showing an example of the configuration of the game system 10 where the game according to the exemplary embodiment is performed.

As shown in FIG. 6, the game system 10 where the game according to the exemplary embodiment is performed includes a first information processing apparatus 1a and a second information processing apparatus 1b. As shown in FIG. 6, for example, the first information processing apparatus 1a operates in the above stationary mode and is connected to the stationary monitor 5 via the cradle 6 (not shown). To the first information processing apparatus 1a, the controller (the first controller or the second controller) (not shown) is wirelessly connected. For example, the second information processing apparatus 1b operates in the mobile mode.

The first information processing apparatus 1a may operate in the mobile mode, or may be operate in the table mode. The second information processing apparatus 1b may operate in the stationary mode, or may operate in the table mode.

For example, the first information processing apparatus 1a stores a game program for performing the game according to the exemplary embodiment, executes the game program, and functions as a parent apparatus. The second information processing apparatus 1b does not execute the game program, and functions as a child apparatus.

Here, the description is given on the assumption that the first information processing apparatus 1a functions as the parent apparatus, and the second information processing apparatus 1b functions as the child apparatus. However, the second information processing apparatus 1b may function as the parent apparatus, and the first information processing apparatus 1a may function as the child apparatus.

The first information processing apparatus 1a as the parent apparatus acquires parent apparatus operation data relating to an operation on the controller (the first controller or the second controller) of the first information processing apparatus 1a. The second information processing apparatus 1b as the child apparatus acquires operation data relating to an operation on the controller or the touch panel 13b of the second information processing apparatus 1b and transmits the operation data as child apparatus operation data to the parent apparatus. The parent apparatus performs game processing based on the parent apparatus operation data and the child apparatus operation data and generates a first image and a second image that is a UI image based on the result of the game processing. The parent apparatus displays the generated first image on the stationary monitor 5 and transmits the generated second image to the child apparatus. The child apparatus displays the second image received from the parent apparatus on a display 12b of the child apparatus.

As described above, in the exemplary embodiment, a game that uses two screens is performed using the parent apparatus and the child apparatus. The game according to the exemplary embodiment is exemplified below.

In the game according to the exemplary embodiment that uses the first information processing apparatus 1a and the second information processing apparatus 1b, for example, an image of a virtual space is displayed as the first image, and a map image of the virtual space is displayed as the second image. For example, the game according to the exemplary embodiment may be a game where a player character 71 moves in the virtual space and is headed for a predetermined destination. For example, the game according to the exemplary embodiment is performed by a single user.

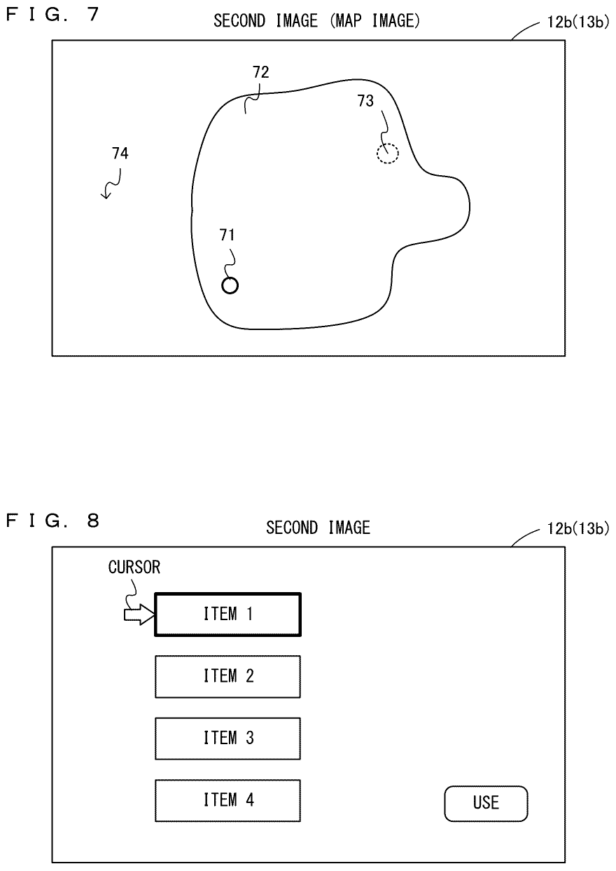

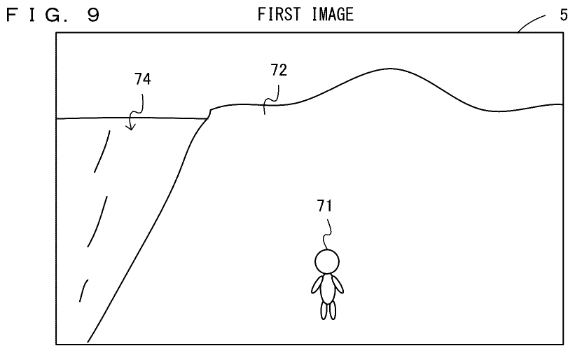

FIG. 7 is a diagram showing an example of the second image displayed on the display 12b of the child apparatus in a case where the game according to the exemplary embodiment is performed. FIG. 8 is a diagram showing another example of the second image displayed on the display 12b of the child apparatus in a case where the game according to the exemplary embodiment is performed. FIG. 9 is a diagram showing an example of the first image displayed on the stationary monitor 5 connected to the parent apparatus in a case where the game according to the exemplary embodiment is performed.

As shown in FIG. 9, an image of the virtual space (the first image) including the player character 71 controlled by the user is displayed on the stationary monitor 5 connected to the parent apparatus. The first image includes an image representing a terrain such as a ground 72, a sea 74, and the like. The first image is an image representing the range of a part of the virtual space including the player character 71, and for example, is generated based on a virtual camera placed behind the player character 71. The player character 71 moves on the ground 72 in accordance with an operation on the controller of the parent apparatus and is headed for a destination in the virtual space. In FIG. 9, the destination is away from the position of the player character 71, and therefore, an image representing the destination is not displayed in the first image.

On the other hand, as shown in FIG. 7, the map image representing a range wider than the first image is displayed as the second image on the display 12b of the child apparatus. The second image may be the map image representing the entirety of the virtual space, or may be the map image representing a part of the virtual space wider than the first image. For example, the second image includes an icon indicating the player character 71, an image representing the ground 72 where the player character 71 can move, an image representing the sea 74 where the player character 71 cannot move, and an icon indicating a destination 73.

The user moves the player character 71 by operating the controller connected to the parent apparatus while viewing the first image. If the player character 71 moves in the virtual space, the image of the virtual space after the movement is displayed as the first image on the stationary monitor 5. The map image relating to the position of the player character 71 after the movement is also displayed as the second image on the display 12b.

Specifically, the parent apparatus updates the position of the player character 71 and also updates the position of the virtual camera based on parent apparatus operation data from the controller (the first controller or the second controller) wirelessly connected to the parent apparatus. The parent apparatus updates the position of the icon of the player character 71 in the map image based on the updated position of the player character 71. Then, the parent apparatus generates the first image that is the image of the virtual space based on the virtual camera, and displays the first image on the stationary monitor 5. The parent apparatus also generates the second image that is the map image, and transmits the second image to the child apparatus. The child apparatus displays the received second image on the display 12b.

The user can grasp the positional relationship between the player character 71 and the destination 73 while viewing the second image displayed on the display 12b of the child apparatus, and confirm the direction in which the player character 71 should move.

The user may be able to perform an operation on the controller (the first controller or the second controller) of the child apparatus. The user may also be able to perform an operation on the touch panel 13b of the child apparatus. Child apparatus operation data relating to an operation on the controller or the touch panel 13b of the child apparatus may be transmitted to the parent apparatus, game processing may be performed by the parent apparatus, and the second image relating to the result of the game processing may be displayed on the display 12b. For example, a predetermined position in the map image may be indicated in accordance with an operation on the controller or the touch panel 13b of the child apparatus, and information regarding the indicated position may be displayed on the display 12b.

Game processing may be performed by the parent apparatus based on an operation on the controller or the touch panel 13b of the child apparatus, and the first image relating to the result of the game processing may be displayed on the stationary monitor 5. For example, as shown in FIG. 8, as another example of the second image, an item selection screen for selecting any of a plurality of items may be displayed, and an item selected on the item selection screen may be used and reflected on the first image.

Specifically, as shown in FIG. 8, icons indicating a plurality of items are displayed on the display 12b of the child apparatus. For example, the plurality of items may be a weapon used for an attack by the player character 71, a protective gear with which the player character 71 is equipped, an item that recovers the physical strength of the player character 71, and the like. The user selects any of the icons using a cursor and uses the item relating to the selected icon using a use button based on an operation on the controller or the touch panel 13b of the child apparatus. If the item is used, display relating to the used item may be performed in the first image shown in FIG. 9. For example, if a weapon is used as an item, the state where the player character 71 equipped with the weapon performs an attack action may be displayed.

The player character 71 displayed in the first image may be controlled using the controller or the touch panel 13b of the child apparatus. For example, the player character 71 may be moved based on an operation on the controller of the child apparatus, and the first image and the second image relating to the position of the player character 71 after the movement may be generated and displayed on the stationary monitor 5 and the display 12b, respectively.

Here, the game according to the exemplary embodiment can be executed by connecting the child apparatus to the parent apparatus and based on two screens using the parent apparatus and the child apparatus as described above, but can also be executed using only a single information processing apparatus 1. In this case, the game according to the exemplary embodiment is performed on a single screen. Here, the case where the game is performed on a single screen is referred to as a “single-screen mode”. In contrast, the case where the game is executed on two screens using the parent apparatus and the child apparatus as described above is referred to as a “two-screen mode”. A description is given below of the case where the game according to the exemplary embodiment is performed in the single-screen mode.

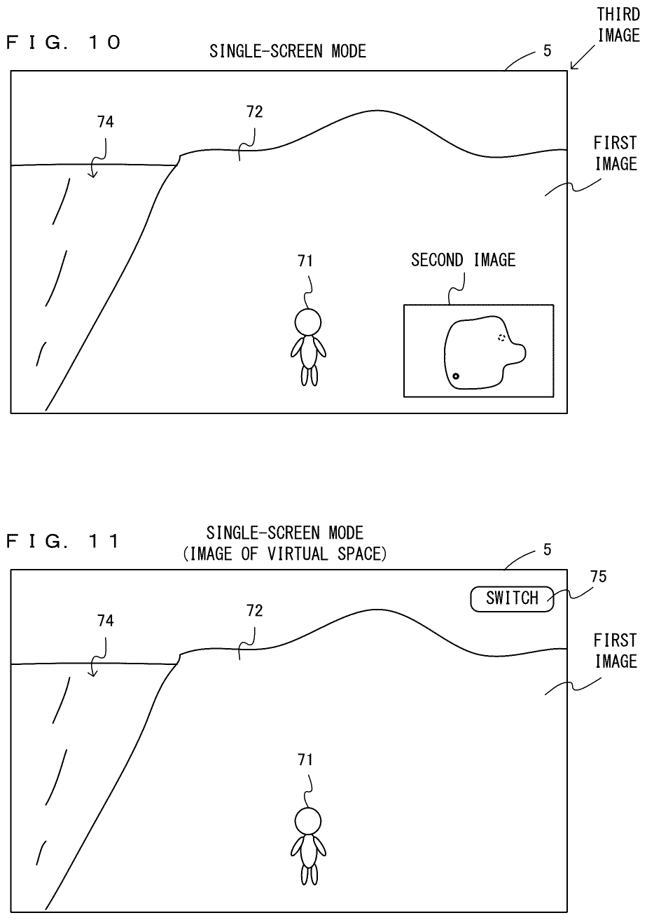

FIG. 10 is a diagram showing an example of, in a case where the game according to the exemplary embodiment is executed using a single information processing apparatus 1, an image displayed on a display device of the information processing apparatus 1.

As shown in FIG. 10, in a case where the game according to the exemplary embodiment is executed, for example, using only the first information processing apparatus 1a, a third image obtained by superimposing a second image that is a map image on a first image that is an image of a virtual space is displayed on the stationary monitor 5 of the first information processing apparatus 1a. The user advances the game while viewing the first image and the second image simultaneously displayed on a single screen.

Specifically, the first information processing apparatus 1a updates the position of the player character 71 or causes the player character 71 to perform a predetermined action as game processing based on operation data from the controller (the first controller or the second controller) wirelessly connected to the first information processing apparatus 1a. The first information processing apparatus 1a updates the position of the icon of the player character 71 in the map image in accordance with the update of the position of the player character 71. The first information processing apparatus 1a generates the first image, generates the second image that is the map image, and generates the third image obtained by superimposing the second image on the first image based on the virtual camera. Then, the first information processing apparatus 1a displays the generated third image on the stationary monitor 5.

No matter which of the mobile mode, the stationary mode, and the table mode the first information processing apparatus 1a operates in, the first information processing apparatus 1a can execute the game in the single-screen mode. If the first information processing apparatus 1a operates in the mobile mode or the table mode, the third image is displayed on the display 12.

In a case where the game is performed in the single-screen mode, the first image and the second image may not be simultaneously displayed, and only either one of the first image and the second image may be displayed. For example, normally, only the first image that is the image of the virtual space may be displayed, and the first image may switch to the second image that is the map image in accordance with a switching operation of the user using the controller. If the user performs the switching operation again, the second image may switch to the first image.

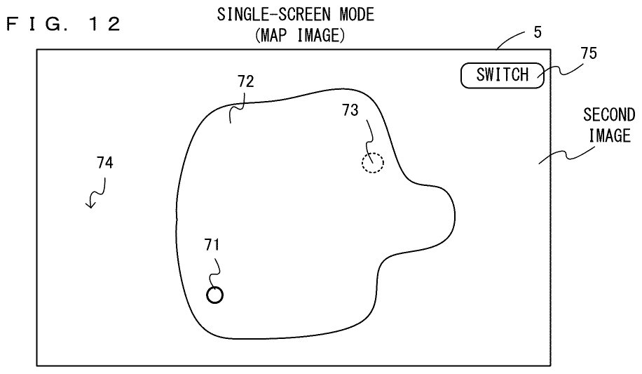

FIG. 11 is a diagram showing an example of the first image displayed on the stationary monitor 5 connected to the information processing apparatus 1 in a case where the game is performed in the single-screen mode. FIG. 12 is a diagram showing an example of the second image displayed on the stationary monitor 5 connected to the information processing apparatus 1 in a case where the game is performed in the single-screen mode.

As shown in FIG. 11, in a case where the game is performed in the single-screen mode, the image of the virtual space based on the virtual camera is displayed as the first image on the entire screen of the stationary monitor 5. The first image displayed in the single-screen mode is an image similar to the first image displayed in the two-screen mode (see FIG. 9). In the single-screen mode, however, for example, a switch button 75 is included in the first image. For example, if the user selects the switch button 75 and performs the switching operation using the controller of the information processing apparatus 1, as shown in FIG. 12, the map image is displayed as the second image on the entire screen of the stationary monitor 5. The second image displayed in the single-screen mode is an image similar to the second image displayed in the two-screen mode (see FIG. 7). In the single-screen mode, however, for example, the switch button 75 is included in the second image. If the user selects the switch button 75 included in the second image and performs the switching operation, the first image shown in FIG. 11 is displayed.

In the single-screen mode, the first image and the second image may be switched using not only the switch button 75 but also another user interface. For example, the first image and the second image may be switched using a menu. The first image may be switched to another image in accordance with the switching operation. For example, the first image may be switched to the item selection screen shown in FIG. 8 in accordance with the switching operation.

As shown in FIG. 10, in a case where the second image is displayed in a superimposed manner on the first image, there is a possibility that the visibility of the first image decreases. The second image is displayed small, and there is a possibility that the visibility of the second image also decreases.

In a case where the game is executed in the single-screen mode, and if the first image and the second image are not simultaneously displayed and only either one of the first image and the second image is displayed as shown in FIGS. 11 and 12, for example, the user needs to perform the switching operation for switching screens to view the map image.

In contrast, in a case where the game is executed on two screens using the parent apparatus and the child apparatus as described above, either one of the first image and the second image is displayed on the display device (the stationary monitor 5 or the display 12a) of the parent apparatus, and the other image is displayed on the display device (the stationary monitor 5 or the display 12b) of the child apparatus. This enables the user to perform the game while simultaneously viewing the first image and the second image without impairing the visibilities of both the first image and the second image.

The game according to the exemplary embodiment is performed by a single user. The game according to the exemplary embodiment may be performed by two users, using the parent apparatus and the child apparatus. For example, a first user may operate the player character 71 using the controller of the parent apparatus while viewing the first image displayed on the display device of the parent apparatus, and a second user may perform a game operation using the controller of the child apparatus while viewing the second image displayed on the display device of the child apparatus and provide information to the user of the parent apparatus.

### Exemplification of Application Performed in Game System

Next, a description is given of a case where a predetermined application different from the above game is performed in the game system (an information processing system) shown in FIG. 6. In the predetermined application, for example, an image of a plurality of items as selection targets is displayed as a second image. An image relating to a selected item is also displayed as a first image. For example, a karaoke application may be executed as the predetermined application. In the karaoke application, a user selects any of a plurality of compositions, and a process relating to the selected composition is performed.

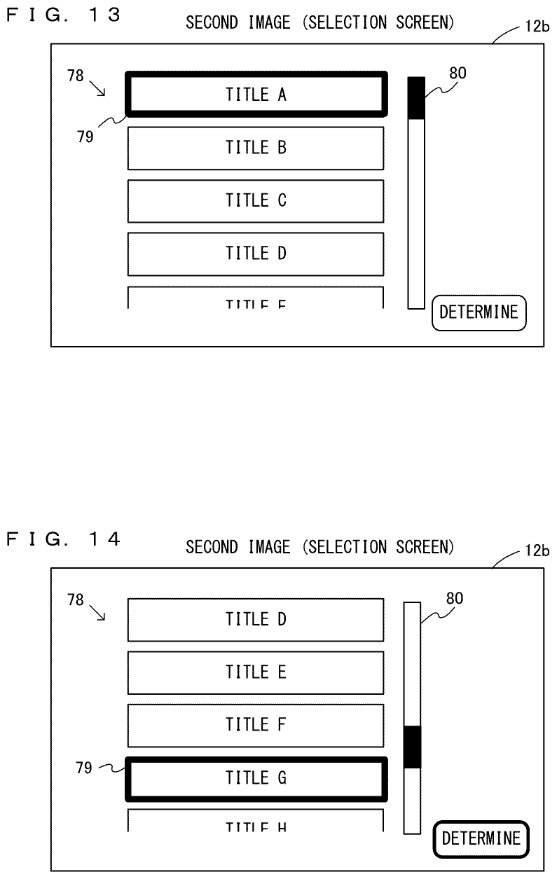

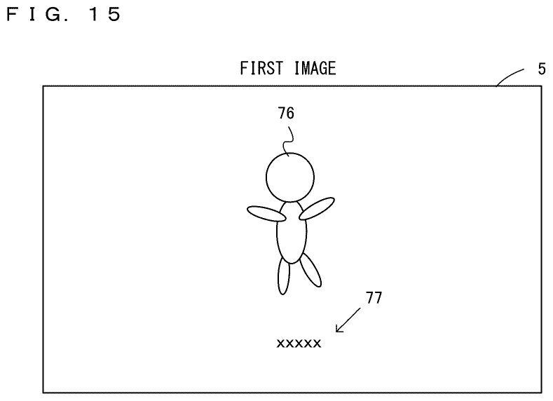

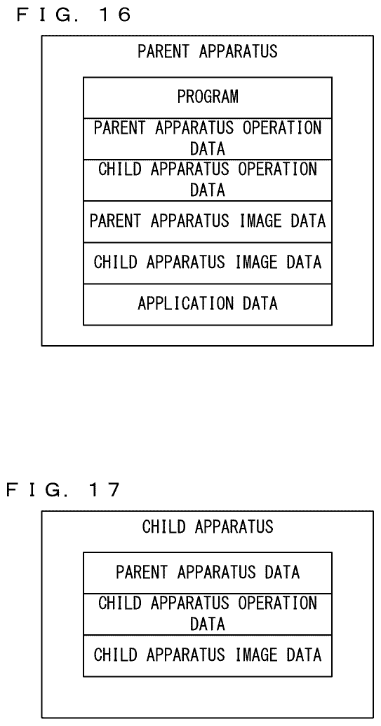

FIGS. 13 and 14 are diagrams showing examples of the second image displayed on the display 12b of the child apparatus in a case where the predetermined application is executed. FIG. 15 is a diagram showing an example of the first image displayed on the stationary monitor 5 connected to the parent apparatus in a case where the predetermined application is executed.

As shown in FIGS. 13 and 14, a composition selection screen for allowing the user to select any of a plurality of compositions is displayed as the second image on the display 12b of the child apparatus. On the composition selection screen, a plurality of composition icons 78 relating to the plurality of compositions are displayed as a list. For example, the titles of the compositions are displayed in the composition icons 78. A cursor 79 for selecting a composition and a scroll bar 80 are displayed. In the second image, some of the plurality of compositions configured to be selected by the user are displayed, and if the user moves the cursor 79 in the down direction, the displayed range changes. The user selects any one of the plurality of composition icons 78 by moving the cursor 79 by a selection operation using the controller or the touch panel 13b of the child apparatus. In the state where any one of the plurality of composition icons 78 is selected, the user performs a determination operation using the controller or the touch panel 13b of the child apparatus.

As shown in FIG. 14, if the determination operation is performed in the state where the composition icon 78 indicating a title G is selected on the composition selection screen, the reproduction of the composition relating to the selected composition icon (the composition with the title G) is started, and as shown in FIG. 15, the first image related to the composition that is being reproduced is also displayed on the stationary monitor 5 of the parent apparatus. For example, a character 76 related to the composition that is being reproduced may be displayed as the first image. An image 77 representing the lyrics (characters or a character image) of the composition that is being reproduced is also displayed as the first image. The character 76 may be a character set in advance, or may be a character relating to the user.

For example, a microphone is connected to the parent apparatus, and the voice of the user is input to the parent apparatus using the microphone. The parent apparatus acquires sound input data that uses the microphone as parent apparatus operation data. A microphone may be connected to the child apparatus, and sound input data that uses the microphone may be transmitted as child apparatus operation data from the child apparatus to the parent apparatus.

The parent apparatus performs predetermined application processing based on an input of the user. For example, the parent apparatus evaluates the input (the voice) of the user as the application processing and displays the result of the evaluation on the stationary monitor 5. The character 76 may perform an action in accordance with the input of the user.

As described above, in the application according to the exemplary embodiment, a selection screen for allowing the user to select any of a plurality of items is displayed on the display device of the child apparatus, and the first image relating to an item selected on the selection screen is displayed on the display device of the parent apparatus.

On the composition selection screen, the plurality of compositions configured to be selected by the user may not be simultaneously displayed, and only any one of the plurality of compositions may be displayed. In this case, the composition displayed on the composition selection screen changes by the selection operation using the controller of the child apparatus. Then, if the determination operation is performed by the user in the state where any of the plurality of compositions is displayed, the reproduction of the displayed composition is started, and the first image shown in FIG. 15 is displayed on the stationary monitor 5 of the parent apparatus.

Similarly to the above game, the predetermined application can also be executed in the single-screen mode, for example, using only the first information processing apparatus 1a. If the predetermined application is executed in the single-screen mode, a third image obtained by superimposing the second image (the composition selection screen) on the first image may be displayed on the display device of the first information processing apparatus 1a. For example, if the predetermined application is started in the single-screen mode, first, the second image (the composition selection screen) may be displayed on the display device of the first information processing apparatus 1a. If a composition is selected on the composition selection screen, the reproduction of the composition may be started, and the second image may switch to the first image shown in FIG. 15.

In a case where the predetermined application is executed in the single-screen mode, the first image and the second image may not be simultaneously displayed, and the first image and the second image may switch in accordance with the switching operation of the user. For example, during the display of the first image (during the reproduction of a composition), the second image (the composition selection screen) may be displayed in accordance with the switching operation of the user.

As the predetermined application for selecting a composition using the composition selection screen, a rhythm game may be performed. In this case, the composition selection screen as shown in FIGS. 13 and 14 is displayed as the second image. If a composition is selected on the composition selection screen and the determination operation is performed, the reproduction of the selected composition is started, and a game image is also displayed as the first image related to the composition that is being reproduced. For example, the first image includes an icon (an instruction image) indicating the timing of an input of the user. Specifically, icons indicating a plurality of timings set in advance are displayed moving in accordance with the rhythm of the composition that is being reproduced. In game processing regarding the rhythm game, the parent apparatus determines whether the timing when an icon reaches a predetermined area matches the timing when an input of the user is provided. Then, the parent apparatus calculates the score in accordance with the result of the determination. Then, the parent apparatus generates the first image relating to the result of the game processing and displays the first image on the stationary monitor 5. The input of the user may be provided using the first controller or the second controller connected to the parent apparatus, or may be provided using a dedicated input device connected to the parent apparatus. The input of the user may also be provided using the first controller or the second controller connected to the child apparatus, or may also be provided using a dedicated input device connected to the child apparatus.

In a case where predetermined information processing (the above game processing or the above application processing) is performed using the parent apparatus and the child apparatus as described above, either one of the first image and the second image that is the UI image is displayed on the display device of the parent apparatus (the stationary monitor 5 or the display 12), and the other image is displayed on the display device (the stationary monitor 5 or the display 12) of the child apparatus. The UI image is displayed on a different screen, whereby it is possible to improve the visibilities of the first image and the second image. It is also possible to perform an operation using the controllers of the parent apparatus and the child apparatus. Thus, it is possible to improve convenience for the user.

In the above exemplary embodiment, a single child apparatus is connected to a parent apparatus, a first image is displayed on the parent apparatus, and a second image that is a UI image is displayed on the child apparatus. In another exemplary embodiment, a plurality of child apparatuses may be connected to a parent apparatus, a first image may be displayed on the parent apparatus, and a second image that is a UI image may be displayed on each of the plurality of child apparatuses. In this case, the parent apparatus generates second images for the child apparatuses and transmits the different second images to the child apparatuses. The second images displayed on the plurality of child apparatuses may be viewed by a single user, or may be viewed by a plurality of users. The plurality of child apparatuses may be operated by a single user, or may be operated by a plurality of users.

### Details of Processes of Parent Apparatus and Child Apparatus

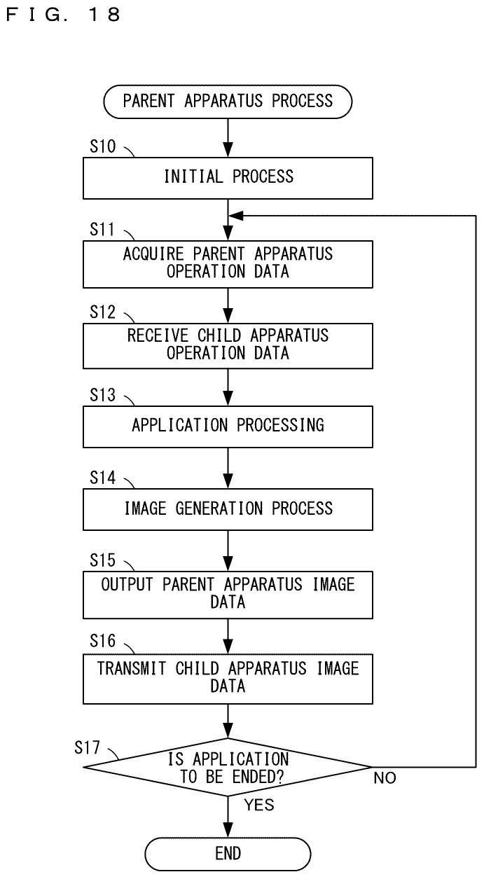

Next, the details of processes performed by a parent apparatus and a child apparatus are described. First, data stored in the parent apparatus and the child apparatus is described. FIG. 16 is a diagram showing an example of the data stored in the parent apparatus. FIG. 17 is a diagram showing an example of the data stored in the child apparatus. The data shown in FIGS. 16 and 17 is stored in a memory (any of an external storage medium, the flash memory 84, and the DRAM 85) of each main body apparatus 2.

As shown in FIG. 16, the parent apparatus stores a program, child apparatus data, parent apparatus operation data, child apparatus operation data, parent apparatus image data, child apparatus image data, and application data.

The program is a program for executing an application and is, for example, a program for executing the game according to the exemplary embodiment. The program may be a program for executing the above karaoke application.

The child apparatus data is data regarding a child apparatus connected to the parent apparatus. For example, the child apparatus data includes information (e.g., an apparatus ID, a MAC address, or the like) that identifies the child apparatus. The child apparatus data is stored with respect to each child apparatus connected to the parent apparatus.

The parent apparatus operation data is data relating to an operation performed on the controller (the first controller or the second controller) of the parent apparatus. The main body apparatus 2 acquires the parent apparatus operation data from the controller of the parent apparatus at predetermined time intervals (e.g., 1/200-second intervals). The parent apparatus operation data may include data relating to a touch operation on the touch panel 13 of the main body apparatus 2.

The child apparatus operation data is data relating to an operation performed on the controller (the first controller or the second controller) of the child apparatus and is transmitted from the child apparatus. The child apparatus operation data may include data relating to a touch operation on the touch panel 13 of the main body apparatus 2. The child apparatus transmits the child apparatus operation data to the parent apparatus at predetermined time intervals (e.g., 1/60-second intervals). In a case where a plurality of child apparatuses are connected to the parent apparatus, the child apparatus operation data received from each of the child apparatuses is stored.

The parent apparatus image data is image data indicating an image displayed on the screen of the parent apparatus (the screen of the display 12 or the stationary monitor 5) and is generated by the parent apparatus.

The child apparatus image data is image data indicating an image displayed on the screen of the child apparatus (the screen of the display 12 or the stationary monitor 5) and is data generated by the parent apparatus and transmitted to the child apparatus. In a case where a plurality of child apparatuses are connected to the parent apparatus, the child apparatus image data of each of the plurality of child apparatuses is generated and stored. The image size (the resolution) of the child apparatus image data may be variable. For example, the image size of the child apparatus image data may change in accordance with the number of child apparatuses connected to the parent apparatus. The image size of the parent apparatus image data and the image size of the child apparatus image data may be different from each other.

The application data is data used in the application. For example, in a case where the game shown in FIGS. 7 to 9 is performed, data regarding the player character 71, data regarding the terrain representing the ground 72 and the sea 74, data regarding the destination 73, data regarding various objects placed in the virtual space, data regarding the map image, and the like are stored as the application data. The data regarding the player character 71 includes data indicating the shape and the external appearance of the player character 71 and data indicating the position and the direction in the virtual space of the player character 71.

For example, in a case where the karaoke application shown in FIGS. 13 to 15 is executed, data regarding the plurality of compositions, data regarding the composition selection screen, and the like are stored as the application data. The data regarding the composition selection screen includes data indicating the composition icons 78 relating to the compositions and data indicating the cursor 79.

On the other hand, as shown in FIG. 17, the child apparatus stores parent apparatus data, child apparatus operation data, and child apparatus image data.

The parent apparatus data is data regarding a parent apparatus connected to the child apparatus. For example, the parent apparatus data includes information (e.g., an apparatus ID, a MAC address, or the like) that identifies the parent apparatus.

The child apparatus operation data is data relating to an operation performed on the controller (the first controller or the second controller) of the child apparatus. The main body apparatus 2 acquires the child apparatus operation data from the controller of the child apparatus at predetermined time intervals (e.g., 1/200-second intervals). The child apparatus operation data may include data relating to a touch operation on the touch panel 13 of the main body apparatus 2. The child apparatus transmits the acquired child apparatus operation data to the parent apparatus at predetermined time intervals (e.g., 1/60-second intervals).

The child apparatus image data is image data indicating an image displayed on the screen of the child apparatus (the screen of the display 12 or the stationary monitor 5) and is data received from the parent apparatus.

The child apparatus does not store the above program, but stores a program for participating in the application performed by the parent apparatus (a program for connecting to the parent apparatus, a program for making a participation request to the parent apparatus, or the like).

Next, the processes performed by the parent apparatus and the child apparatus are described. The following description is given on the assumption that a parent apparatus and child apparatuses are connected together in the communication form shown in FIG. 4. A parent apparatus and child apparatuses may be connected together in the communication form shown in FIG. 5.

### Parent Apparatus Process

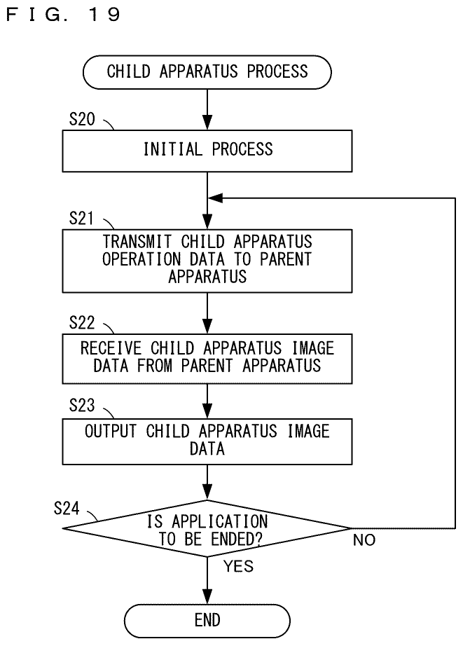

FIG. 18 is a flow chart showing an example of a parent apparatus process performed by the parent apparatus. The process shown in FIG. 18 is performed by the processor 81 of the main body apparatus 2 as the parent apparatus.

As shown in FIG. 18, first, the parent apparatus performs an initial process (step S10). In the initial process, based on an operation of a user, the process of determining an application to be executed, the process of selecting a communication form (the local communication or the Internet communication), the process of setting an information processing apparatus 1 as the parent apparatus, the process of connecting the parent apparatus and a child apparatus, a process for inviting a user (a child apparatus) to participate in the application, a process for causing a child apparatus that makes a participation request to participate in the application, and the like are performed. A communication form that configured to be selected by the user differs in accordance with the application to be executed. If the initial process ends, the parent apparatus starts the application, and from this point onward, repeatedly executes the processes of steps S11 to S17 at predetermined time intervals (e.g., 1/60-second intervals).

After the process of step S10, the parent apparatus acquires parent apparatus operation data (step S11). Specifically, if the parent apparatus operates in the mobile mode, the parent apparatus acquires parent apparatus operation data from the first controller (the left controller 3 and the right controller 4) attached to the parent apparatus. If the parent apparatus operates in the stationary mode or the table mode, the parent apparatus acquires parent apparatus operation data from the first controller or the second controller wirelessly connected to the parent apparatus. The parent apparatus may acquire data relating to a touch operation on the touch panel 13 of the main body apparatus 2 as parent apparatus operation data.

Next, the parent apparatus receives child apparatus operation data from child apparatuses (step S12). Specifically, the network communication section 82 of the parent apparatus receives child apparatus operation data transmitted from each child apparatus. The timings when the parent apparatus receive the child apparatus operation data from the child apparatuses may be different from each other.

Next, the parent apparatus performs application processing based on the parent apparatus operation data (step S13). In step S13, the parent apparatus also performs application processing based on the received child apparatus operation data.

For example, in a case where the game shown in FIGS. 7 to 9 is performed as the application, the parent apparatus updates the position of the player character 71 or causes the player character 71 to perform a predetermined action based on the parent apparatus operation data. The parent apparatus also moves the virtual camera in accordance with the movement of the player character 71.

In a case where the karaoke application shown in FIGS. 13 to 15 is executed, the parent apparatus selects any one of the plurality of compositions based on the child apparatus operation data. For example, when the composition selection screen is displayed on the display device (the display 12 or the stationary monitor 5) of the child apparatus, the parent apparatus moves the cursor 79 and selects any one of the plurality of composition icons 78 based on the child apparatus operation data. If the determination operation is performed by the user, the parent apparatus starts the reproduction of the selected composition. During the reproduction of the composition, the parent apparatus causes the character 76 to perform an action and evaluates the user based on the parent apparatus operation data (e.g., sound input data) as the application processing.

Next, the parent apparatus performs an image generation process based on the result of the application processing (step S14). Specifically, in the image generation process, the parent apparatus generates parent apparatus image data and child apparatus image data. The parent apparatus may also generate parent apparatus sound data and child apparatus sound data.

For example, in a case where the above game is performed, the parent apparatus generates a first image (an image of the virtual space) as shown in FIG. 9 as parent apparatus image data. The parent apparatus also generates a second image (a map image) as shown in FIG. 7 as child apparatus image data.

In a case where the above karaoke application is performed, the parent apparatus generates a first image as shown in FIG. 15 as parent apparatus image data. The parent apparatus also generates a second image as shown in FIGS. 13 and 14 as child apparatus image data.

Next, the parent apparatus outputs the parent apparatus image data generated in step S14 to the display 12 or the stationary monitor 5 (step S15). The parent apparatus also outputs a sound based on the parent apparatus sound data generated in step S14 from the speakers 88 or the speaker of the stationary monitor 5.

Next, the parent apparatus transmits the child apparatus image data generated in step S14 to the child apparatuses (step S16). Specifically, the network communication section 82 of the parent apparatus transmits the generated child apparatus image data to the child apparatuses. The network communication section 82 of the parent apparatus also transmits the generated sound data to the child apparatuses.

Next, the parent apparatus determines whether or not to end the application (step S17). For example, if the application is completed, or if the user of the parent apparatus gives an instruction to force termination of the application during the execution of the application, or if child apparatus operation data regarding forced termination of the application is received from any of the child apparatuses during the execution of the application, the determination of the parent apparatus is YES in step S17. If the determination is YES in step S17, the parent apparatus ends the application and transmits an application end notification to the child apparatuses. If the determination is NO in step S17, the parent apparatus executes the process of step S11 again. The description of the parent apparatus process ends.

While the processes of steps S11 to S17 are repeatedly executed, i.e., while an application is performed between the parent apparatus and the child apparatuses, a new child apparatus may participate.

### Child Apparatus Process

FIG. 19 is a flow chart showing an example of a child apparatus process performed by the child apparatus.

As shown in FIG. 19, first, the child apparatus performs an initial process (step S20). In the initial process, based on an operation of a user, the process of setting an information processing apparatus 1 as the child apparatus, the process of selecting a parent apparatus to which to connect, a process for transmitting a participation request to participate in an application performed by the parent apparatus, and the like are performed. If the application is started by the parent apparatus, the child apparatus ends the initial process. From this point onward, the child apparatus repeatedly executes the processes of steps S21 to S24 at predetermined time intervals (e.g., 1/60-second intervals).

If the application is started, the child apparatus transmits child apparatus operation data to the parent apparatus (step S21). Specifically, if the child apparatus operates in the mobile mode, the child apparatus acquires operation data output from the first controller (the left controller 3 and the right controller 4) attached to the child apparatus. If the child apparatus operates in the stationary mode or the table mode, the child apparatus acquires operation data output from the first controller or the second controller connected to the child apparatus. The child apparatus may acquire data relating to a touch operation on the touch panel 13 of the main body apparatus 2 as operation data. Then, the network communication section 82 of the child apparatus transmits the acquired operation data as child apparatus operation data to the parent apparatus. Operation data output from the controller of the child apparatus may be transmitted as child apparatus operation data to the parent apparatus, or data obtained by performing a predetermined process on operation data output from the controller of the child apparatus may be transmitted as child apparatus operation data to the parent apparatus.

Next, the child apparatus receives child apparatus image data from the parent apparatus (step S22). The child apparatus may also receive child apparatus sound data from the parent apparatus.

The frequency of transmission of the child apparatus operation data from the child apparatus and the frequency of reception (the frame rate) of the child apparatus image data by the child apparatus may be different from each other. For example, the frequency of reception of the child apparatus image data may be lower than the frequency of transmission of the child apparatus operation data. For example, in accordance with the number of child apparatuses connected to the parent apparatus, the frequencies of reception of the child apparatus image data by the child apparatuses may be lowered. In this case, the frequencies of transmission of the child apparatus operation data from the child apparatuses may be the same as each other, regardless of the number of child apparatuses connected to the parent apparatus.

Next, the child apparatus outputs the received child apparatus image data (step S23). Specifically, if the child apparatus operates in the mobile mode or the table mode, the child apparatus outputs the received child apparatus image data to the display 12. If the child apparatus operates in the stationary mode, the child apparatus outputs the received child apparatus image data to the stationary monitor 5. The child apparatus may also output a sound based on the received sound data.

Next, the child apparatus determines whether or not to end the application (step S24). For example, if the child apparatus receives an application end notification from the parent apparatus, or if an instruction to force termination of the application is given in the child apparatus during the execution of the application, the child apparatus ends the application. If the application is not to be ended, the child apparatus executes the process of step S21 again. The description of the child apparatus process ends.

The processes of the above flow charts are merely examples, and for example, the order of steps may be switched, another step may be added, or some of the above steps may be omitted.

As described above, an information processing apparatus according to the exemplary embodiment operates in a mobile mode, a stationary mode, and a table mode as a plurality of play forms. In the mobile mode, the information processing apparatus performs a process relating to an operation on an operation device included in the information processing apparatus (e.g., the left controller 3 and the right controller 4 attached to the main body apparatus or the touch panel 13) and outputs an image relating to the result of the process to a display device (e.g., the display 12) included in the information processing apparatus. In the stationary mode, the information processing apparatus performs a process relating to an operation on an operation device externally connected to the information processing apparatus (e.g., the first controller or the second controller wirelessly connected to the main body apparatus) and outputs an image relating to the result of the process to a display device (e.g., the stationary monitor 5) externally connected to the information processing apparatus. In the table mode, the information processing apparatus performs a process relating to an operation on the operation device externally connected to the information processing apparatus (e.g., the first controller or the second controller wirelessly connected to the main body apparatus) and outputs an image relating to the result of the process to the display device (e.g., the display 12) included in the information processing apparatus. The information processing apparatus can also communicate with another information processing apparatus in a plurality of communication forms including Internet communication and wireless local communication.

An information processing system composed of a first information processing apparatus and a second information processing apparatus that are such information processing apparatuses is configured. The first information processing apparatus can perform information processing (e.g., the above game processing or the above application processing) based on operation data in a first mode (the single-screen mode) and a second mode (the two-screen mode) and generate a first image and a second image that is a UI image based on the information processing.

Specifically, in the first mode, the first information processing apparatus performs information processing based on first input data relating to an operation on an operation device included in or connected to the information processing apparatus (e.g., the left controller 3 and the right controller 4 attached to the main body apparatus, the touch panel 13, or the first controller or the second controller wirelessly connected to the main body apparatus). In the first mode, the first information processing apparatus also generates a first image and a second image based on the information processing and outputs an image including one of the first image and the second image selected in a switchable manner based on operation data or both the first image and the second image to a display device (e.g., the display 12 or the stationary monitor 5) included in or connected to the information processing apparatus.

In the second mode, the first information processing apparatus communicates with the second information processing apparatus. The second information processing apparatus transmits second input data relating to an operation on an operation device included in or connected to the second information processing apparatus (e.g., the left controller 3 and the right controller 4 attached to the main body apparatus, the touch panel 13, or the first controller or the second controller wirelessly connected to the main body apparatus) to the first information processing apparatus. The first information processing apparatus performs the information processing based on at least either of first input data and the second input data, outputs one of the first image and the second image to the display device, and transmits the other image to the second information processing apparatus. The second information processing apparatus outputs the other image received from the first information processing apparatus to a display device (e.g., the display 12 or the stationary monitor 5) included in or connected to the second information processing apparatus.

For example, the first image may be an image of a virtual space based on a virtual camera, and the second image may be a map image in a game. The second image may be an image representing any of a plurality of items as selection targets. A selectable item may be a composition, a selected composition may be reproduced, and an image related to the composition that is being reproduced may be displayed as the first image.

The second image may be an image for providing information to a user. The second image may also be an image for the user to provide an input.

In another exemplary embodiment, application processing regarding not only the game and the application exemplified above but also any application may be executed by a parent apparatus.

While the exemplary embodiment has been described, the above description is merely illustrative, and the exemplary embodiment may be improved and modified in various manners.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable media having stored therein instructions that, when executed, cause one or more processors of a first information processing apparatus to execute information processing comprising:
in a first mode,
performing information processing using first input data based on an operation input to an operation device included in or connected to the first information processing apparatus as operation data, and
outputting an image including one of a first image and a second image selected in a switchable manner based on the operation data or both the first image and the second image to a display device included in or connected to the first information processing apparatus; and
in a second mode,
communicating with a second information processing apparatus,
performing the information processing using at least either of first input data and second input data received from the second information processing apparatus as the operation data,
outputting one of the first image and the second image to the display device, and
transmitting the other image to the second information processing apparatus.

2. The one or more non-transitory computer-readable media according to claim 1, wherein
the information processing is game processing, and
the first image is an image of a virtual space based on a virtual camera.

3. The one or more non-transitory computer-readable media according to claim 2, wherein
the second image at least includes a map image in a game.

4. The one or more non-transitory computer-readable media according to claim 1, wherein
the second image at least includes an image representing an item as a selection target, and
the information processing further comprises
performing a selection process for selecting the item at least based on the operation data.

5. The one or more non-transitory computer-readable media according to claim 4, wherein
the item is a composition, and
the information processing further comprises:
reproducing the selected composition; and
generating an image related to the composition that is being reproduced as the first image.

6. The one or more non-transitory computer-readable media according to claim 1, wherein
the second input data includes touch input data regarding an input to a touch panel provided in the second information processing apparatus, and
the information processing further comprises
in the second mode,
performing the information processing using the second input data as the operation data, and
selecting a selectable item included in a UI of the second image based on the touch input data.

7. An information processing system comprising:
one or more processors; and
one or more non-transitory computer-readable media having stored therein instructions that, when executed, cause the one or more processors to execute information processing comprising:
in a first information processing apparatus,
in a first mode,
performing information processing using first input data based on an operation input to an operation device included in or connected to the first information processing apparatus as operation data, and
outputting an image including one of a first image and a second image selected in a switchable manner based on the operation data or both the first image and the second image to a display device included in or connected to the first information processing apparatus; and
in a second mode,
communicating with a second information processing apparatus,
performing the information processing using at least either of first input data and second input data received from the second information processing apparatus as the operation data,
outputting one of the first image and the second image to the display device, and
transmitting the other image to the second information processing apparatus, and
in the second information processing apparatus,
communicating with the first information processing apparatus,
transmitting the second input data based on an operation input to an operation device included in or connected to the second information processing apparatus to the first information processing apparatus, and
outputting the other image received from the first information processing apparatus to a display device included in or connected to the second information processing apparatus.

8. The information processing system according to claim 7, wherein
the information processing is game processing, and
the first image is an image of a virtual space based on a virtual camera.

9. The information processing system according to claim 8, wherein
the second image at least includes a map image in a game.

10. The information processing system according to claim 7, wherein
the second image at least includes an image representing an item as a selection target, and
the information processing further comprises,
in the first information processing apparatus,
performing a selection process for selecting the item at least based on the operation data.

11. The information processing system according to claim 10, wherein
the item is a composition, and
in the first information processing apparatus, the information processing further comprises:
in the first information processing apparatus,
reproducing the selected composition; and
generating an image related to the composition that is being reproduced as the first image.

12. The information processing system according to claim 7, wherein
the second input data includes touch input data regarding an input to a touch panel provided in the second information processing apparatus, and
the information processing further comprises
in the first information processing apparatus,
in the second mode,
performing the information processing using the second input data as the operation data, and
selecting a selectable item included in a UI of the second image based on the touch input data.

13. An information processing method performed by an information processing system including a first information processing apparatus and a second information processing apparatus, the information processing method comprising:
in the first information processing apparatus,
in a first mode,
performing information processing using first input data based on an operation input to an operation device included in or connected to the first information processing apparatus as operation data, and
outputting an image including one of a first image and a second image selected in a switchable manner based on the operation data or both the first image and the second image to a display device included in or connected to the first information processing apparatus; and
in a second mode,
communicating with a second information processing apparatus,
performing the information processing using at least either of first input data and second input data received from the second information processing apparatus as the operation data,
outputting one of the first image and the second image to the display device, and
transmitting the other image to the second information processing apparatus, and
in the second information processing apparatus,
communicating with the first information processing apparatus,
transmitting the second input data based on an operation input to an operation device included in or connected to the second information processing apparatus to the first information processing apparatus, and
outputting the other image received from the first information processing apparatus to a display device included in or connected to the second information processing apparatus.

14. The information processing method according to claim 13, wherein
the information processing is game processing, and
the first image is an image of a virtual space based on a virtual camera.

15. The information processing method according to claim 14, wherein
the second image at least includes a map image in a game.

16. The information processing method according to claim 13, wherein
the second image at least includes an image representing an item as a selection target, and
the information processing method further comprises
in the first information processing apparatus,
performing a selection process for selecting the item at least based on the operation data.

17. The information processing method according to claim 16, wherein
the item is a composition, and
the information processing method further comprises:
in the first information processing apparatus,
reproducing the selected composition; and
generating an image related to the composition that is being reproduced as the first image.

18. The information processing method according to claim 13, wherein
the second input data includes touch input data regarding an input to a touch panel provided in the second information processing apparatus, and
the information processing method further comprises
in the first information processing apparatus,
in the second mode,
performing the information processing using the second input data as the operation data, and
selecting a selectable item included in a UI of the second image based on the touch input data.

19. An information processing apparatus comprising:
one or more processors; and
one or more non-transitory computer-readable media having stored therein instructions that, when executed, cause the one or more processors to execute information processing comprising:
in a first mode,
performing information processing using first input data based on an operation input to an operation device included in or connected to the information processing apparatus as operation data, and
outputting an image including one of a first image and a second image selected in a switchable manner based on the operation data or both the first image and the second image to a display device included in or connected to the information processing apparatus; and
in a second mode,
communicating with a second information processing apparatus,
performing the information processing using at least either of first input data and second input data received from the second information processing apparatus as the operation data,
outputting one of the first image and the second image to the display device, and
transmitting the other image to the second information processing apparatus.

20. The information processing apparatus according to claim 19, wherein
the information processing is game processing, and
the first image is an image of a virtual space based on a virtual camera.

21. The information processing apparatus according to claim 20, wherein
the second image at least includes a map image in a game.

22. The information processing apparatus according to claim 19, wherein
the second image at least includes an image representing an item as a selection target, and
the information processing further comprises
performing a selection process for selecting the item at least based on the operation data.

23. The information processing apparatus according to claim 22, wherein
the item is a composition, and
the information processing further comprises:
reproducing the selected composition; and
generating an image related to the composition that is being reproduced as the first image.

24. The information processing apparatus according to claim 19, wherein
the second input data includes touch input data regarding an input to a touch panel provided in the second information processing apparatus, and
the information processing further comprises
in the second mode,
performing the information processing using the second input data as the operation data, and
selecting a selectable item included in a UI of the second image based on the touch input data.
